(19) United States
(12) Patent Application Publication
(10) Pub. No.: US 2017/0093013 A1
(43) Pub. Date: Mar. 30, 2017

(54) WAVEGUIDE DIRECTIONAL COUPLER

(71) Applicant: U.S.A. as represented by the Administrator of the National Aeronautics and Space Administration, Washington, DC (US)

(72) Inventors: Negar EHSAN, Bethesda, MD (US); Michael A. SOLLY, Odenton, MD (US)

(21) Appl. No.: 14/868,829

(22) Filed: Sep. 29, 2015

(51) Int. Cl. H01P 5/18

(52) U.S. Cl. CPC H01P 5/181; H01P 1/24

(57) ABSTRACT

A directional coupler assembly includes a waveguide housing. The waveguide housing has a first segment and a second segment. A first waveguide port and a second waveguide port are disposed on opposite sides of the waveguide housing. A third waveguide port is disposed on a third side of the waveguide housing, the third waveguide port being disposed substantially orthogonal to the first waveguide port and the second waveguide port. A main coupler board is disposed between the first segment and the second segment and communicatively couples the first waveguide port, the second waveguide port and the third waveguide port.

### INVENTION BY GOVERNMENT EMPLOYEE(S) ONLY

The invention described herein was made by an employee of the United States Government, and may be manufactured and used by or for the Government for governmental purposes without the payment of any royalties thereon or therefor.

### FIELD

The aspects of the present disclosure relate generally to directional couplers, and more particularly to a G-band on-chip/waveguide directional coupler.

### BACKGROUND

Directional couplers are passive radio frequency components used in radio frequency and microwave signal routing for isolating, separating or combining signals. With advances in telecommunications and wireless technologies, directional couplers are required to support wide bandwidth, have high directivity, better coupling and provide better isolation.

Generally, directional couplers three or four-port devices where one port is isolated from the input port. Directional couplers are most frequently constructed from two coupled transmission lines set close enough together such that energy passing through one is coupled to the other. The first port is typically the input, and the second port is typically the output or transmitter. The third port can be categorized as sampling or coupled, while the fourth port is isolated or terminated.

Conventional waveguide couplers at G-band (140 GHz to 200 GHz) that cover the entire band with low coupling factor (<15 dB), generally suffer from transmission loss due to the size of the coupler, which needs to usually be several wavelengths long. In radiometric applications where noise injection at the frontend is desired, a coupler is one of the only approaches. It is important to have as low-loss a coupler as possible at the front-end in order not to affect the sensitivity of the radiometer.

Conventional waveguide couplers are larger in size. It would be advantageous to provide a waveguide coupler that has a smaller scale factor.

Accordingly, it would be desirable to provide a directional coupler that addresses at least some of the problems identified above.

### BRIEF DESCRIPTION OF THE DISCLOSED EMBODIMENTS

As described herein, the exemplary embodiments overcome one or more of the above or other disadvantages known in the art.

One aspect of the exemplary embodiments relates to a directional coupler assembly. In one embodiment, the directional coupler assembly includes a waveguide housing that has a first segment and a second segment. A first waveguide port and a second waveguide port are disposed on opposite sides of the waveguide housing. A third waveguide port is disposed on a third side of the waveguide housing, the third waveguide port being disposed substantially orthogonal to the first waveguide port and the second waveguide port. A main coupler board is disposed between the first segment and the second segment and communicatively couples the first waveguide port, the second waveguide port and the third waveguide port.

Another aspect of the disclosed embodiments is directed to a directional coupler assembly. In one embodiment the directional coupler assembly includes a waveguide housing, a first waveguide, a second waveguide and a third waveguide disposed within the waveguide housing and a main coupler board disposed within the waveguide housing. Tithe main coupler board includes a first transmission line coupling the first waveguide and the second waveguide; a broadband resistor device disposed on the main coupler board; and a second transmission line coupling the third waveguide to the broadband resistor device.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

The accompanying drawings illustrate presently preferred embodiments of the present disclosure, and together with the general description given above and the detailed description given below, serve to explain the principles of the present disclosure. As shown throughout the drawings, like reference numerals designate like or corresponding parts.

FIG. 1 is a plan view of a waveguide directional coupler assembly incorporating aspects of the disclosed embodiments.

FIG. 2 is a side view of a first coupler port for the waveguide directional coupler assembly of FIG. 1.

FIG. 3 is a side view of a second coupler port for the waveguide directional coupler assembly of FIG. 1.

FIG. 4 is a top plan view of segment A of the waveguide directional coupler assembly of FIG. 1.

FIG. 5 is a bottom plan view of segment B of the waveguide directional coupler assembly of FIG. 1.

FIG. 6 is a schematic view of a waveguide directional coupler assembly incorporating aspects of the disclosed embodiments.

FIG. 7 is a graph illustrating full-wave electromagnetic simulation results of a waveguide directional coupler assembly incorporating aspects of the disclosed embodiments.

FIG. 8 is a graph illustrating measured s-parameter results of a waveguide directional coupler assembly incorporating aspects of the disclosed embodiments.

### DETAILED DESCRIPTION OF THE EXEMPLARY EMBODIMENTS OF THE DISCLOSURE

The aspects of the disclosed embodiments are directed to a G-Band chip/waveguide directional coupler that is compatible with standard waveguide flanges at G-band. The G-Band, 156-206 GHz, directional coupler of the disclosed embodiments provides an 11 dB coupling factor, less than 0.8 dB loss, greater than 22 dB isolation, and better than 13 dB return loss across the band. The directional coupler of the disclosed embodiments has less loss compared to existing couplers that cover comparable bandwidth.

Unlike existing couplers at this frequency range, the directional coupler of the disclosed embodiments is designed on a quartz board (on-chip) and is implemented into a waveguide housing. The directional coupler of the disclosed embodiments provides a form factor that is two to three times smaller than conventional waveguide couplers. Also, since the directional coupler of the disclosed embodiments is implemented on a chip it is easily integrated with chip components or on-chip devices such as noise sources and/or LNA. The directional coupler of the disclosed embodiments has a broadband resistor designed into it, eliminating the need for another port or chip resistor.

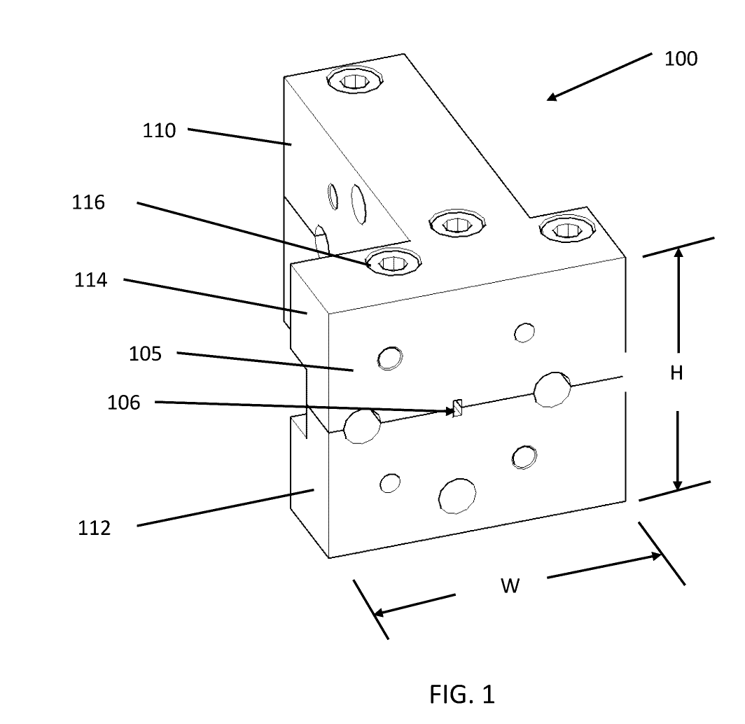

FIG. 1 illustrates an exemplary G-Band chip/waveguide directional coupler assembly 100 incorporating aspects of the disclosed embodiments. In the example shown in FIG. 1, the coupler assembly 100 comprising a main body 110 or waveguide housing. In one embodiment the main body includes a first part or segment 112, referred to herein as “Segment A”, and a second part or segment 114, referred to herein as “Segment B.” Segment A 112 might be considered the bottom half of the assembly 100, while Segment B 114 can be considered the top half. Segment 112 and segment 114 are coupled or secured together by one or more fasteners 116. In the example of FIG. 1, the fasteners 116 are bolts or screws. In alternate embodiments, the segments 112, 114 can coupled or secured together in any suitable manner, other than including bolts or screws.

In the example of FIGS. 1-3, the waveguide housing 110 comprises a brass housing. In alternate embodiments, the waveguide housing 110 can comprise any suitable material, other than including brass.

In one embodiment, the dimensions of the main body 110 comprise a width W of approximately 0.876 inches (22.253 mm); a length L of approximately 1.265 inches (32.14 mm); and a height H of approximately 0.778 inches (19.76 mm). In alternate embodiments, the dimensions of the main body 110 can comprise any suitable dimensions. Generally, the dimensions of the directional coupler assembly 100 can include any limitations in size that are established by standard flange sizes and hardware accommodation.

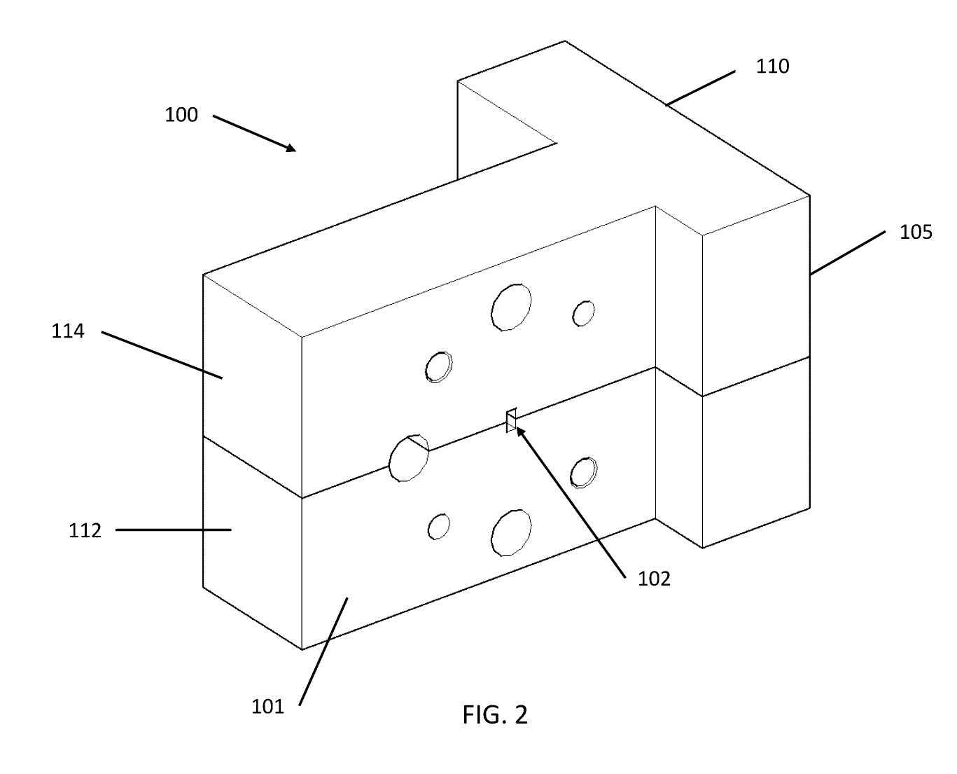

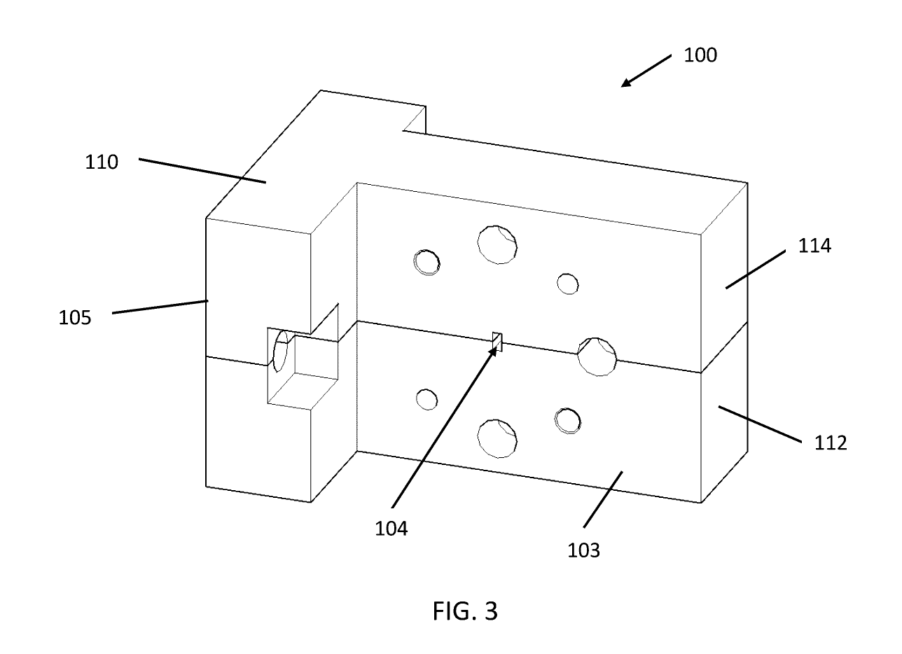

Referring also to FIGS. 2 and 3, the directional coupler assembly 100 of FIG. 1 includes three waveguide ports, as is generally understood. In alternate embodiments, the directional coupler assembly 100 can include any suitable number of ports, other than including three. For example, one embodiment of the directional coupler assembly 100 could include four ports.

In the example of FIGS. 1-3, the assembly 100 includes a first port 102, a second port 104 and a third port 106. The three waveguide ports 102, 104 and 106 comprise WR-5.1 type or sized waveguide ports, for the input, output and coupled ports. In alternate embodiments, the waveguide ports 102, 104 and 106 can include any suitable type or size of waveguide ports, other than including WR-5.1.

As shown in FIGS. 2 and 3, the first and second ports 102, 104 are arranged on first and second sides 101, 103 of the main body 110. The third port 106, shown in FIG. 1, is arranged on a third side 105. The first side 101 and the second side 103 are opposite sides of the main body 110 and disposed substantially parallel to each other. The third side 105 is disposed substantially orthogonal to the first side 101 and the second side 103.

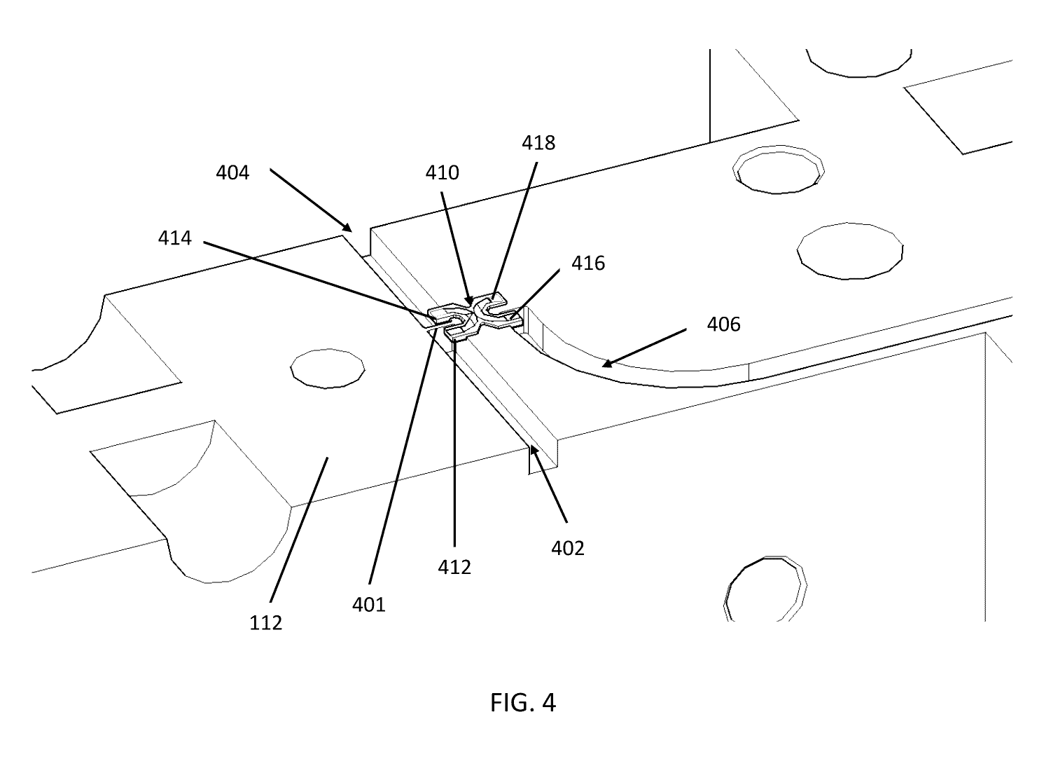

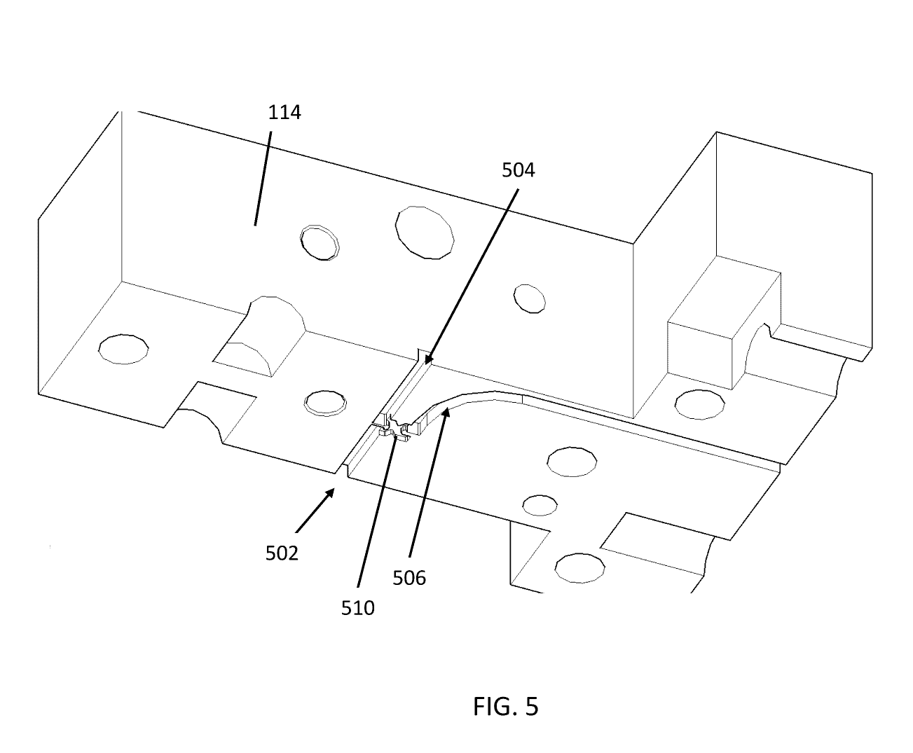

FIG. 4 illustrates a partial top plan view of the segment A 112 of the main body 110 of the directional coupler 100 of the disclosed embodiments. FIG. 5 illustrates a plan view of the segment B 114. In this example, the segment A 112 includes a first waveguide 402, a second waveguide 404 and a third waveguide 406. FIG. 5 illustrates the complimentary waveguide portions 502, 504 and 506 that are formed in segment B 114. For the purposes of the disclosure herein, the waveguides that are formed by the respective segment A 112 and segment B 114 will be referred to as waveguides 402, 404 and 406.

In one embodiment, the first waveguide 402 is coupled to the first port 102, the second waveguide 404 to the second port 104 and the third waveguide 406 to the third port 106. The first waveguide 402 and the second waveguide 404 are generally in-line with each other, separated by a dividing member 401. The size and shape of the waveguides 402, 404, and 406 are selected to provide the smallest loss associated with the length of the respective waveguides.

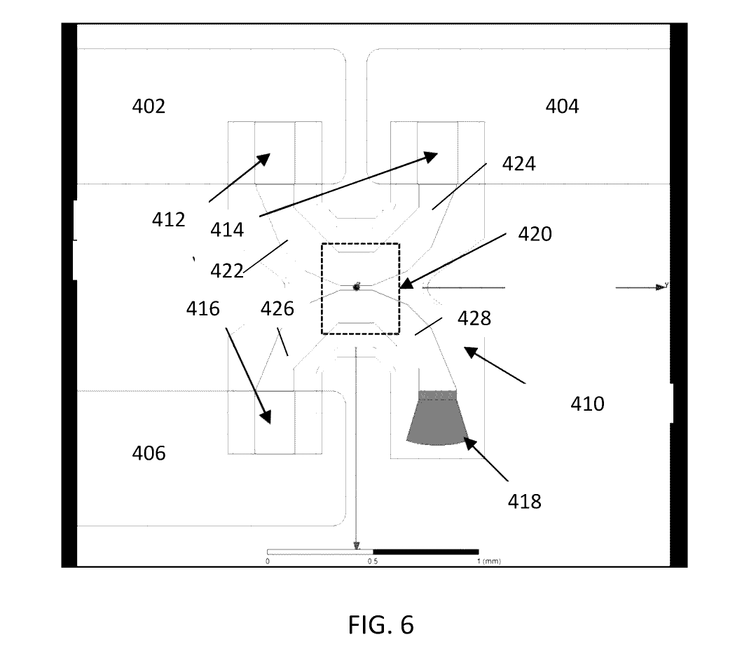

As is shown in FIG. 4, in one embodiment, a main coupler board 410 is positioned at or on the intersection of the first waveguide 402, the second waveguide 404 and the third waveguide 406. The main coupler board 410 is configured to provide the necessary signalling connections and coupling to and between the first, second and third waveguides 402, 404, 406. As shown in FIGS. 4 and 6, the main coupler board 410 includes a first waveguide probe 412, a second waveguide probe 414, a third waveguide probe 416. A broadband resistor device 418 is used for terminating a fourth port of the directional coupler assembly 100.

FIG. 5 illustrates the complimentary waveguide portions 502, 504 and 506. The segment B 114 also includes an opening or area to receive the main coupler board 410. In one embodiment, segment B 114 is designed in conjunction with section A 112 to accommodate the fields with-in the chip coupler, since the coupler fields are with-in the cavity that surrounds the quartz chip and inside the quartz chip.

FIG. 6 is a top view schematic illustration of the waveguide directional coupler assembly 100 of FIG. 1 as simulated via full-wave electromagnetic software. Referring to FIG. 6, the transmission lines 422, 424, 426 and 428 on the coupled board 410 couple the first waveguide probe 412, second waveguide probe 414, third waveguide probe 416 and broadband resistor device 418. The broadband resistor device 418 generally comprises a broadband on-chip resistor. In one embodiment, the resistor device 418 is matched to 50 Ohm with better than 20 dB return loss from 150 GHz to 212 GHz. The sheet resistance of the resistor device 418 can be 75 ohm per square. In one embodiment, the transmission lines 422, 424, 426 and 428 comprise 5 μm copper lines.

In the example of FIG. 6, transmission lines 422 and 424 form a first transmission line coupling the first waveguide port 402 and the second waveguide port 404. The transmission lines 426, 428 form a second transmission line coupling the third waveguide port 406 to the broadband resistor 418. Detail 420 of FIG. 6 illustrates the area of coupling of the first transmission line (422, 424) and the second transmission line (426, 428).

In the example of FIG. 6, a substrate of the main coupler board 410 comprises a quartz substrate or board (e_r=3.8). The quartz coupler board 410 is implemented into the waveguide housing 110 in order to improve the performance (transmission loss, return loss, and isolation), make it easily integrable with other chip devices such as low-noise amplifiers (LNA), noise sources, etc., and ensure its compatibility with standard waveguide flanges at G-band.

In one embodiment, the main coupler board 410 is attached to the waveguide housing 110 via conductive epoxy. In alternate embodiments, the main coupler board 410 can be attached to the waveguide housing 110 in any suitable manner, other than including conductive epoxy. For example, solder paste can be used.

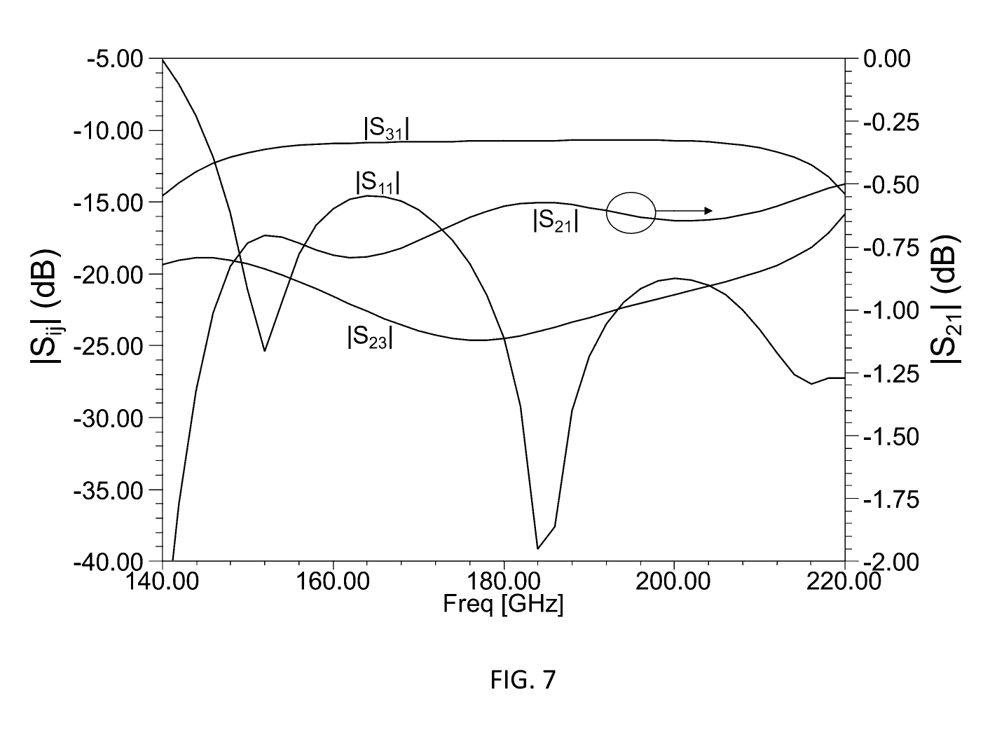

FIG. 7 shows the simulated results of the chip/waveguide coupler shown in FIG. 6. Line |S31| shows the coupling factor which is 11 dB from 156 GHz to 210 GHz. Line |S11| shows the return loss which is greater than 14.5 dB across the band. Line |S23| represent the isolation which is better than 22 dB across the band, and line |S21| shows the transmission factor less than 0.8 dB across the band (−0.5 dB of transmission loss is associated with the coupling factor).

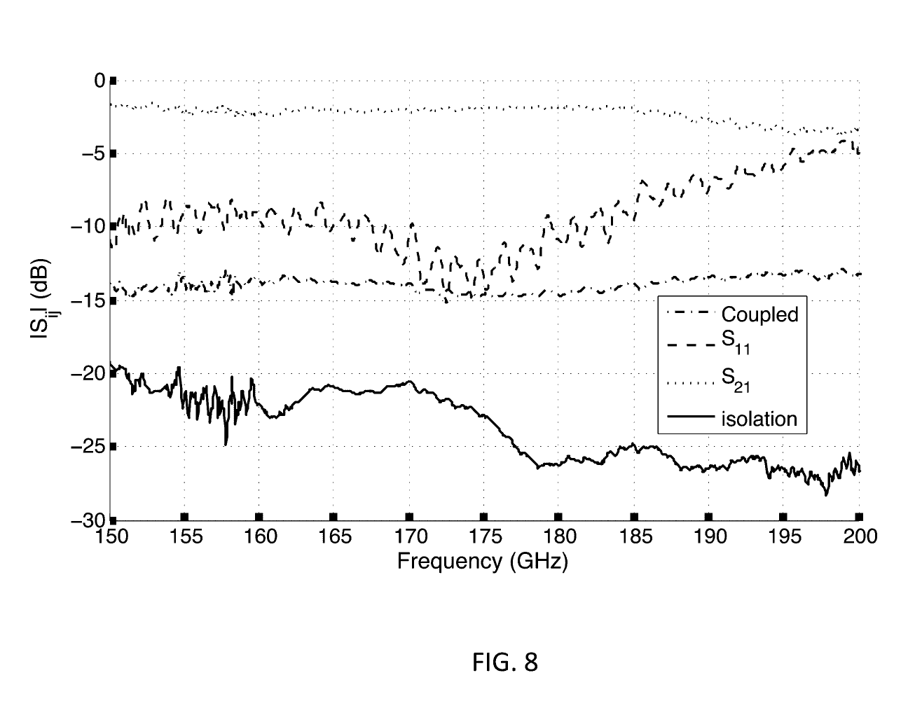

FIG. 8 shows the results of the fabricated model of the directional coupler of the disclosed embodiments. Any discrepancy between the simulated and measured results is mainly associated with the fabrication of the quartz board 410. For example, a mask error can shift the design, resulting in higher coupling, and higher transmission loss.

The aspects of the disclosed embodiments provide a 156-208 GHz chip-waveguide directional coupler has been designed on quartz substrate implemented into a waveguide housing. The directional coupler of the disclosed embodiments includes three waveguide ports for the input, output, and coupled ports. A broadband resistor is designed on chip for terminating the fourth port of the coupler. The design of the coupler is based on a conventional microstrip directional coupler, but since it is designed into an enclosed housing, the fields are confined resulting in better insertion loss, isolation, and return loss compared to a microstrip directional coupler. Compared to waveguide couplers, the directional coupler of the disclosed embodiments has better insertion loss and a smaller footprint. The performance of the direction coupler of the disclosed embodiments has been verified using the full wave electromagnetic simulator HFSS.

Thus, while there have been shown, described and pointed out, fundamental novel features of the invention as applied to the exemplary embodiments thereof, it will be understood that various omissions and substitutions and changes in the form and details of devices and methods illustrated, and in their operation, may be made by those skilled in the art without departing from the spirit of the invention. Moreover, it is expressly intended that all combinations of those elements and/or method steps, which perform substantially the same function in substantially the same way to achieve the same results, are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A directional coupler assembly, comprising:
a waveguide housing, the waveguide housing comprising a first segment and a second segment;
a first waveguide port and a second waveguide port disposed on opposite sides of the waveguide housing;
a third waveguide port disposed on a third side of the waveguide housing, the third waveguide port being disposed substantially orthogonal to the first waveguide port and the second waveguide port;
a main coupler board disposed between the first segment of the waveguide housing and the second segment of the waveguide housing, the main coupler board communicatively coupling the first waveguide port, the second waveguide port and the third waveguide port.

2. The directional coupler assembly of claim 1, wherein the main coupler board comprises:
a first waveguide probe configured to be coupled to the first waveguide port;
a second waveguide probe configured to be coupled to the second waveguide port;
a third waveguide probe configured to be coupled to the third waveguide port; and
a broadband resistor terminating a fourth waveguide port.

3. The directional coupler of claim 2, wherein the main coupler board comprises:
a first transmission line coupling the first waveguide probe and the second waveguide probe;
a second transmission line coupling the third waveguide probe and the broadband resistor; and
a coupling point communicative coupling the first transmission line and the second transmission line.

4. The directional coupler of claim 2, wherein a substrate of the main coupler board comprises a quartz substrate.

5. The directional coupler of claim 1, comprising:
a first waveguide coupling the first waveguide port and the first waveguide probe;
a second waveguide coupling the second waveguide port and the second waveguide probe;
a dividing member separating the first waveguide from the second waveguide, wherein the first waveguide and the second waveguide are disposed substantially in-line with each other; and
a third waveguide coupling the third waveguide port and the third waveguide probe.

6. The directional coupler assembly of claim 5, wherein the third waveguide is disposed substantially orthogonal to the first waveguide and the second waveguide.

7. The directional coupler assembly of claim 1, wherein the directional coupler is a G-Band directional coupler.

8. The directional coupler assembly of claim 1, wherein the main coupler board is enclosed within the waveguide housing between the first segment and the second segment.

9. A directional coupler assembly, comprising:
a waveguide housing, a first waveguide, a second waveguide and a third waveguide disposed within the waveguide housing;
a main coupler board disposed within the waveguide housing, the main coupler board comprising:
a first transmission line coupling the first waveguide and the second waveguide;
a broadband resistor device disposed on the main coupler board; and
a second transmission line coupling the third waveguide to the broadband resistor device.

10. The directional coupler assembly of claim 9, wherein the main coupler board is a quartz board.

11. The directional coupler assembly of claim 9, wherein the waveguide housing comprises a first part and a second part, the main coupler board being disposed between the first part and the second part.

12. The directional coupler assembly of claim 11, wherein the main coupler board is disposed in a cavity defined by the first part and the second part of the waveguide housing.

13. The directional coupler assembly of claim 11, wherein the first part comprises a first waveguide channel, a second waveguide channel and a third waveguide channel in a top surface of the first part of the waveguide housing, the second part comprises a first waveguide channel, a second waveguide channel and a third waveguide channel in a top surface of the second part of the waveguide housing, wherein the first waveguide channel, second waveguide channel and third waveguide channel of the respective first part and second part are joined together to form the first waveguide, the second waveguide and the third waveguide in the waveguide housing.

14. The directional coupler assembly of claim 13, comprising a first waveguide port coupled to the first waveguide, a second waveguide port coupled to the second waveguide and a third waveguide port coupled to the third waveguide.

15. The directional coupler assembly of claim 14, wherein the first waveguide port and the second waveguide port are disposed on opposite sides of the waveguide housing.

16. The directional coupler assembly of claim 14, comprising a fourth waveguide port coupled to the second transmission line, the broadband resistor terminating the fourth waveguide port.

17. The directional coupler assembly of claim 9, comprising a divider formed in the waveguide housing communicatively separating the first waveguide and the second waveguide.

18. The directional coupler assembly of claim 9, wherein the broadband resistor comprises an on-chip resistor.

19. The directional coupler assembly of claim 9, wherein the directional coupler is configured for the 156-206 GHz band.

20. The directional coupler assembly of claim 9, wherein the main coupler board is disposed in a void within the waveguide housing at an intersection of the first waveguide, the second waveguide and the third waveguide.
